(19) United States
(12) Patent Application Publication
(10) Pub. No.: US 2020/0202660 A1
(43) Pub. Date: Jun. 25, 2020

(54) GAMING CABINET WITH HAPTIC FEEDBACK DEVICE

(71) Applicant: Everi Games, Inc., Austin, TX (US)

(72) Inventors: Lawrence J. Knipp, Austin, TX (US); Gregory J. Longendyke, Dripping Springs, TX (US); Heather Valey, Cedar Park, TX (US)

(73) Assignee: Everi Games, Inc., Austin, TX (US)

(21) Appl. No.: 16/228,537

(22) Filed: Dec. 20, 2018

(51) Int. Cl. G07F 17/32; G07F 17/34; A63F 13/28

(52) U.S. Cl. CPC G07F 17/3213; A63F 13/28; G07F 17/34; G07F 17/3206

(57) ABSTRACT

A gaming machine haptic feedback footrest, a host gaming machine, and processes of operation are provide to create haptic feedback. The haptic device is mounted along a lower front face of the cabinet and extends toward a player area in front of the cabinet. The haptic device includes a vibration plate positioned to tilt facing upward and toward the player area as a footrest. A base is provided with a suspension are mounted on the base carrying the vibrational plate and allowing vibrational movement thereof. One or more voice coil vibrating devices mechanically coupled to the vibrational plate along its lower side. An electronic amplifier electrically connected to the voice coil vibrating devices. A process includes activating the electronic amplifier to feed current to one or more voice coil vibrating devices in the haptic device according to the frequencies and durations, thereby activating the vibrational plate.

### TECHNICAL FIELD OF THE INVENTION

The invention relates to multimedia displays for wagering games and to haptic feedback systems.

### BACKGROUND OF THE INVENTION

Various slot machine games are known that provide wagering games in a variety of ways. These games often have background music or a musical soundtrack, which may be consistent with a theme of the game or may include popular music or other suitable soundtrack music.

Haptic feedback, or touch feedback, is known to be used with casino gaming cabinets as well. For example, U.S. Pat. No. 7,578,741 describes a gaming cabinet on which the user input devices such buttons and inputs on the control panel, also provide haptic feedback to a player such as vibrations and movement of the devices.

Generally building haptic feedback into a control deck, such as a ledge holding player controls for the gaming machine, is difficult, requiring that the control deck be mechanically floating with respect to the body of the gaming machine. What is needed are better ways to synchronize designated musical tracks with the presentation of a slot machine game, in order to increase player excitement and enjoyment of slot machine games.

### SUMMARY OF THE INVENTION

The invention solves the problem of being able to provide haptic feedback to a game player better synchronized and integrated with gaming media content and the gaming cabinet. A gaming machine haptic feedback footrest, a host gaming machine, and processes of operation are provide to create haptic feedback. The haptic device is mounted along a lower front face of the cabinet and extends toward a player area in front of the cabinet. The haptic device includes a vibration plate positioned to tilt facing upward and toward the player area as a footrest. A base is provided with a suspension are mounted on the base carrying the vibrational plate and allowing vibrational movement thereof. One or more voice coil vibrating devices mechanically coupled to the vibrational plate along its lower side. An electronic amplifier electrically connected to the voice coil vibrating devices. A process includes activating the electronic amplifier to feed current to one or more voice coil vibrating devices in the haptic device according to the frequencies and durations, thereby activating the vibrational plate.

According to a first embodiment, a gaming machine is provided for conducting a wagering game. The machine includes a display, an audio device, a wager input device, a haptic device mounted along a lower front face of the cabinet and extending toward a player area in front of the cabinet, and at least one electronic controller operatively coupled to the wager input device, the audio device, the haptic device, and the display and configured to execute instructions related to the wagering game and to cause cash value credits to be awarded to a player in response to wagering wins. The haptic device includes a vibration plate positioned to tilt facing upward and toward the player area as a footrest. It also includes a base and a suspension mounted on the base carrying the vibrational plate and allowing vibrational movement of the vibrational plate. One or more voice coil vibrating devices are mechanically coupled to the vibrational plate along its lower side. An electronic amplifier is electrically connected to the voice coil vibrating devices. The machine is run by software programming stored in a tangible, non-transitory electronically accessible memory coupled to the at least one electronic controller. The software includes program code executable by the at least one electronic controller to receive a notification of a gaming event requiring an associated haptic, obtain haptic parameters for the gaming event; and cause the electronic amplifier to drive the voice coil vibrating devices to vibrate according to the haptic parameters.

According to another embodiment, method is given for providing haptic for a wagering game cabinet having a display, a wager input device, an audio device, a display, a haptic device, and at least one electronic controller operatively coupled to the wager input device, the audio device, and the display and configured to execute instructions related to the wagering game. The method includes receiving an instruction that a haptic event is to occur during a game play session, and in response, processing haptic parameters to determine one or more frequencies and durations for the haptic event. The method activates an electronic amplifier to feed current to one or more voice coil vibrating devices in the haptic device according to the frequencies and durations, thereby vibrating a plate positioned as a footrest associated with the gaming machine.

In various implementations, the frequencies for the haptic event include audio frequencies. The frequencies for the haptic event may also include subsonic frequencies. The method may include synchronizing animations of gaming symbols on an array of symbols presented on the display to subsonic vibrations of the haptic device. The method may also include synchronizing lighting events on a lighting display associated with the gaming machine to subsonic vibrations of the haptic device.

Another version of the invention is a gaming system that includes one or more gaming servers, and a group of electronic gaming machines connected to the servers by a network, programmed as set forth above.

The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results received from the server in an entertaining manner. However, other embodiments might use a thin client architecture in which the animation is also conducted by the server, and electronic gaming machines serve merely as a terminal to receive button or touch screen input from the player and to display graphics received from the server.

These and other advantages and features of the invention will be apparent from the following description of the preferred embodiments, considered along with the accompanying drawings.

### BRIEF DESCRIPTION OF THE DRAWINGS

FIG. 1A is a front perspective view of a gaming machine cabinet having a haptic feedback footrest.

FIG. 1B is a front perspective view of the same cabinet with a haptic feedback footrest exploded forward of the cabinet.

FIG. 2A-2E are different views of the haptic feedback footrest.

FIG. 2A is a front perspective view with the footrest assembled.

FIG. 2B is a front perspective view with the vibrating plate exploded from the base.

FIG. 2C is a bottom perspective view.

FIG. 2D a cross section view taken longitudinally down the center.

FIG. 2E is a perspective cross section side view with the base portion removed.

FIGS. 3A and 3B are side cross section views of the vibrating plate portion only, showing relative movement of the haptic feedback element and the vibrating plate.

FIGS. 4A-4C are a series of side cross section views of the haptic feedback footrest showing vibrational movement.

FIG. 5 is a cross section view of an example design for a haptic feedback element according to another embodiment.

FIG. 6 is a flowchart of a process for operating a gaming machine with a haptic feedback device according to an example embodiment.

FIG. 7 is a system block diagram of a gaming system according to one embodiment of the present invention.

### DETAILED DESCRIPTION OF PREFERRED EMBODIMENTS

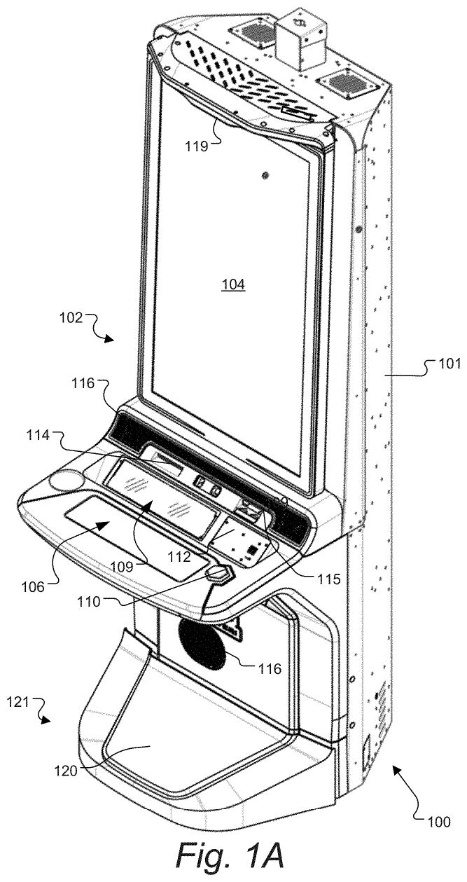

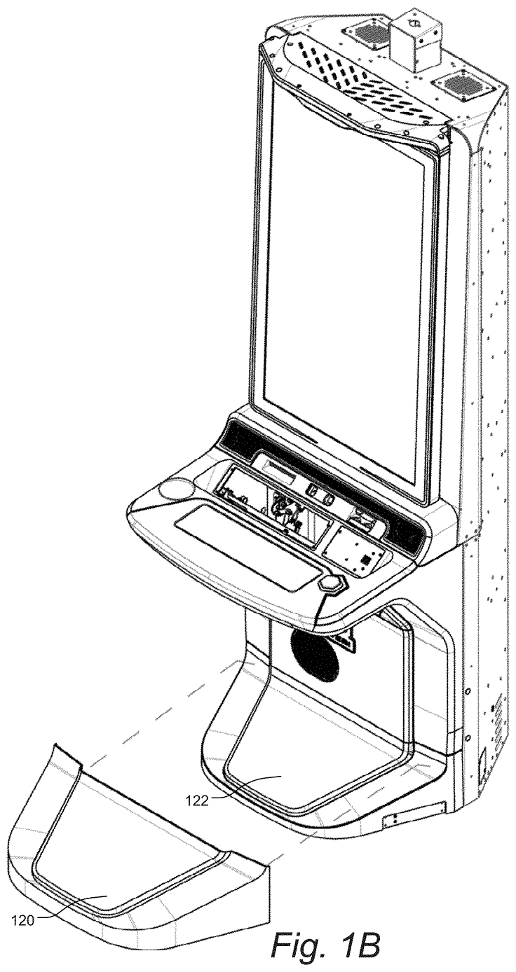

FIG. 1A is a front perspective view of a gaming machine cabinet 100.

FIG. 1B is a front perspective view of the same cabinet with a haptic feedback footrest exploded forward of the cabinet. Gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 may include a secondary video display device positioned above the primary video display device. Gaming machine 100 also an additional smaller auxiliary display device 109 positioned inset at an angle toward the back of ledge 106, which is typically a touchscreen display for player control input. It should also be noted that each display device referenced herein may include any suitable display device including a cathode ray tube, liquid crystal display, plasma display, LED display, or any other type of display device currently known or that may be developed in the future.

In preferred versions, the gaming machine 100 also includes a number of mechanical control buttons 110 mounted on ledge 106. These control buttons 110 may allow a player to select a bet level, select pay lines, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Decorative lights 119 are placed, in this version, along the top of the machine and may also be placed along the edges of display 104 and in other suitable locations such a topper light on the top surface, along the machine's belly (the front panel under the ledge 106) or behind translucent portions of the machine belly glass, or on the cabinet sides as well. These lights may be controlled to dim, flash, change colors, or otherwise alter along with the musical beats as described herein. Numerous other types of devices may be included in gaming machines that may be used according to the present invention.

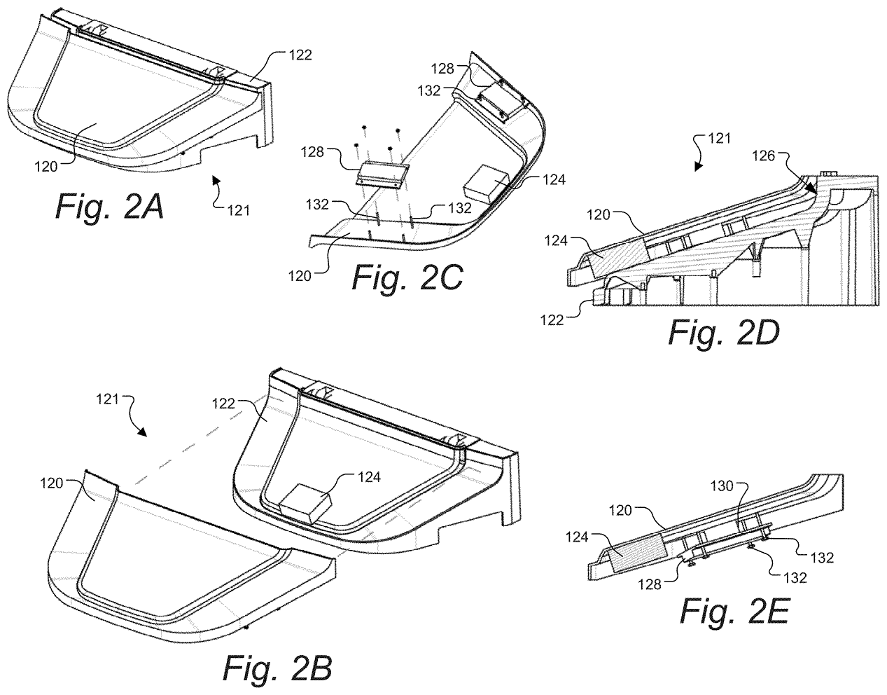

A haptic feedback footrest is generally indicated by 121 and includes a vibration plate 120 mounted over a base 122. FIG. 2A-2E are different views of the haptic feedback footrest 121. FIG. 2A is a front perspective view with the footrest assembled. FIG. 2B is a front perspective view with the vibrating plate exploded from the base. FIG. 2C is a bottom perspective view. FIG. 2D a cross section view taken longitudinally down the center. FIG. 2E is a perspective cross section side view with the base portion removed. Referring to FIGS. 2A-E, base 122 is mounted along the lower front face of cabinet 100 and extends toward a player area in front of the cabinet. Vibration plate 120 is positioned to tilt facing upward and toward the player area as a footrest, mounted above base 122 with a suspension 124 mounted on the base carrying the vibrational plate and allowing vibrational movement of the vibrational plate. As seen in FIG. 2D, vibration plate 120 rests on base 122 at a region 126 along its proximal edge, and rests near its distal edge on suspension 124. Suspension 124 may be any suitable material or structure to allow vibrating motion of vibration plate 120, including foam, a spring suspension, or a cylinder air suspension arrangement, for example. In this version suspension 124 is a foam block. Vibration plate 120 is generally constructed of molded plastic shaped to fit as depicted over base 122, but may be any suitable material or combination of materials to provide a strong rigid footrest. Base 122 may also be constructed of molded plastic, a composite, metal, or combinations thereof.

In the depicted version, two coil vibrating devices 128 are mechanically coupled to the vibrational plate 120 along its lower side. One or more such devices may be employed in various embodiments. As seen in FIG. 2E, voice coil vibrating devices 128 are mechanically coupled to vibrating plate 120 with a respective rigid mechanical coupling such as the depicted tube 130. In this embodiment, voice coil vibration devices are used, but in other embodiments other types of haptic feedback devices may be used. Further, while a tube is used here, other suitable structures may be used to provide a rigid, enclosed coupling for linking vibrating device 128 to vibrational plate 120. Tube 130 in this version is constructed of carbon fiber and cemented to a cone inside vibrating device 128 as will be further described below. The vibrating footrest also includes an electronic amplifier electrically connected to the voice coil vibrating devices, which may be in base 122, inside the device 128, or inside cabinet 100. In this version, each several retaining studs 130 are also mounted to vibrational plate 120 and mechanically coupled to voice coil vibrational device 128 allowing movement along the stud by passing each stud through a hole as shown in FIGS. 2C and 2E, and securing a nut or other stud head on the opposite side. In this version, retaining studs 130 serve protect the voice coil vibrational device 128 against damage during transportation and assembly, but may also serve to stabilize the position of device 128 against undesired movement of vibrational plate 120.

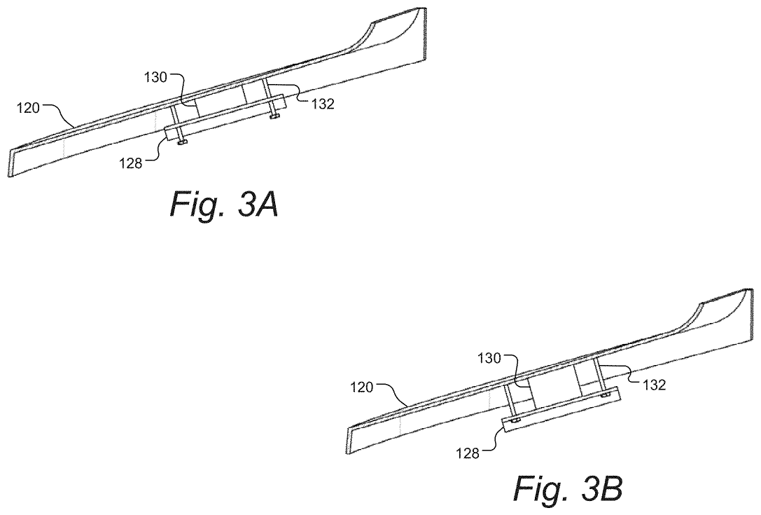

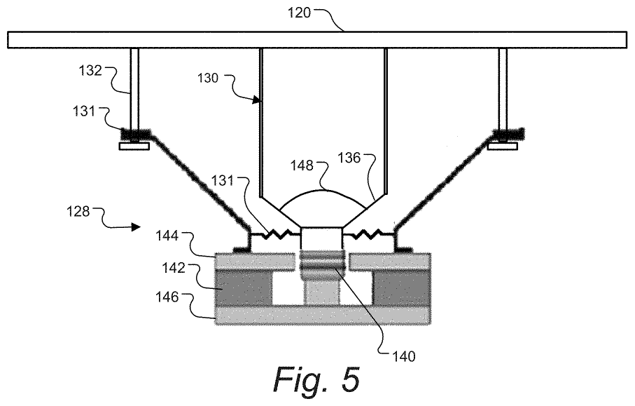

FIGS. 3A and 3B are side cross section views of the vibrating plate 120, showing relative movement of the vibrating device 128 and the vibrating plate 120. Vibrating force in the interior voice coil of vibrating device 128 causes movement back and forth in the longitudinal direction of retaining studs 132, creating the depicted displacements. While tube 130 may seem to be expanding as shown, what is actually happening in the preferred version is the tube, which is rigid, is pushed further out of vibrating device 128 by a vibrating cone (FIG. 5).

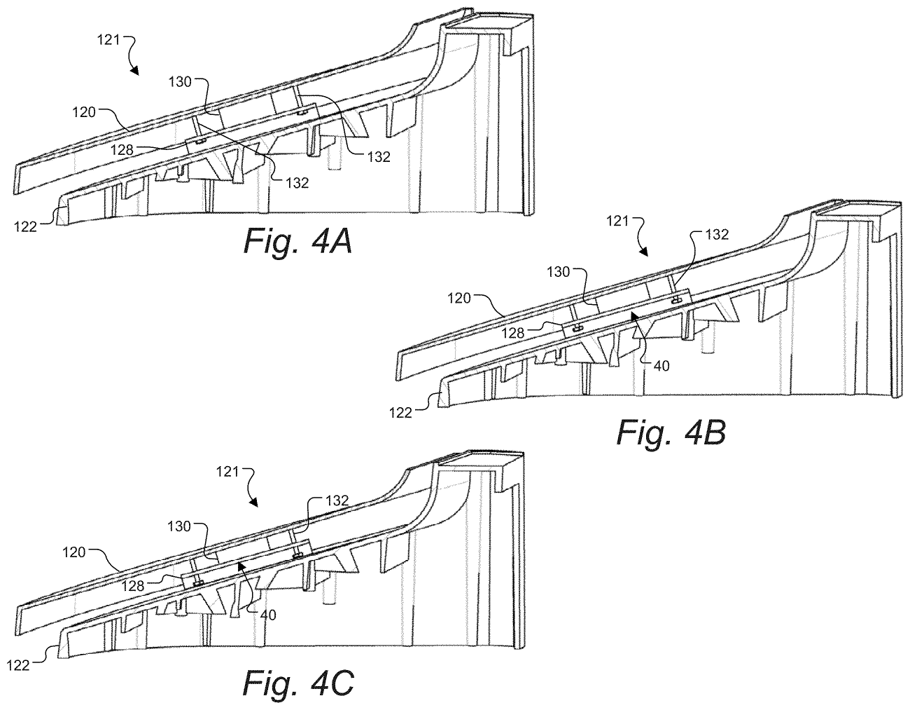

FIGS. 4A-4C are a series of side cross-section views of the haptic feedback footrest 121 showing vibrational movement. The movement of vibrational plate 120 may be seen relative to base 122. FIG. 4A shows an upper extent of the vibrational movement with tube 130 extended at a maximum vertical extension form vibrating device 128. FIG. 4B shows the device midway through a maximum vibrational movement. FIG. 4C shows the device the maximum contracted position of a vibrating movement in which retaining studs 132 have their heads flush against the upper surface of base 122. As can be seen, vibrating device 128 is mounted along the upper surface of base 122 and thereby causes vibrating motion of vibrating plate 120.

FIG. 5 is a partial cross-section diagram showing construction of an example vibrating device 128. In this version, a voice coil 140 and partial speaker cone 136 are employed in the vibrating device 128, similar bass audio speaker construction. Tube 130 is cemented or otherwise bonded vibrating plate 120 and to speaker cone 136, which contrasts with known speaker designs in that speaker cone 136 is truncated and does not extend to the upper-depicted end of the spider structure 131. The spider structure 131 is a metallic or semi-rigid plastic structure constructed of materials typically used for a spider in a bass audio speaker. Retaining studs 132 are passed through holes in a distal portion of spider structure 131. Typically spider structure 131 surrounds the interior depicted portions on at least two sides and may surround on all sides. A voice coil or audio coil 140 is fixed in a central void of magnet 142, on a base attached to rear pole piece 146. Spider structure 131 is attached front pole piece 144. The design of this embodiment allows components of a bass speaker (the magnets, pole pieces, audio coil, and spider structure) to be employed with certain modifications to produce vibrating device 128. In construction, the components may be purpose built, purpose assembled, or modified from a bass speaker assembly. When modifying a bass speaker assembly, speaker cone 136 is truncated preferably in a circle around dust cap 148, and tube 130 bonded along or near the truncated edge as depicted. In operation, when audio coil 140 is supplied with an alternating current signal, mechanical vibrating displacement occurs allowing bending of the inner depicted portions of spider 131, and deforming movement of speaker cone 136 to apply vibrating force through cone 130 to vibrating plate 120.

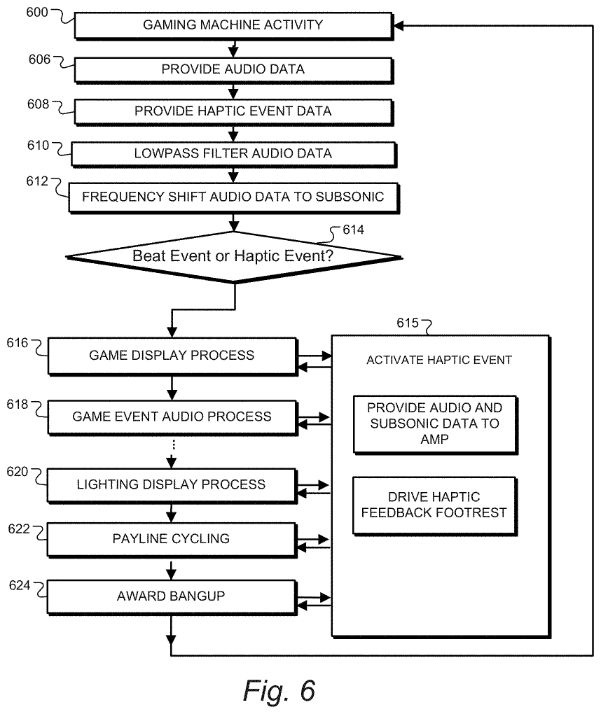

FIG. 6 is a flowchart of a process conducted with the gaming machine according an example embodiment. Generally a process of providing haptic feedback through haptic feedback footrest 121 may be integrated with a process of providing synchronization of gaming events to musical beats in soundtrack audio provided by the gaming machine. Such a system is found in co-pending U.S. patent application Ser. No. 15/240,857 by Steven Meyer, which is owned by the present applicant. The techniques herein may be used to add haptic feedback to any of the audio outputs provided by this prior system of similar systems. The entire contents of this prior application are hereby incorporated by reference for all purposes. The process may include haptic feedback for any suitable gaming machine activity as shown at block 600. Audio data such as music data or gaming audio is provided to the process at block 606. Some gaming events may include pre-designed haptic data including an associated sonic and or subsonic signal, and associated settings such as gain settings provided at block 608 for driving the vibrating device 128. Data to drive the vibrating device 128 may also be generated by the process at block 610 and 612, where the process lowpass filters audio data to isolate low, bass frequencies from the gaming audio which may be employed to provide haptic feedback. At block 612, the process may frequency shift the filtered data to a subsonic frequency in order to provide a slower, lower frequency, vibration for the haptic feedback than that found in bass music frequencies. At block 614, the process any gaming events that are designated to include haptic feedback causes the process to move to block 615 to provide a haptic feedback event with suitable data driving the vibrating device 128. Haptic events may be synchronized with audio beat events generated by an audio synchronization system such as that found in the patent application incorporated above. Block 616, 618, 620, 622, and 624 shown show several example events for which the process provides synchronization of the background music or haptic events to the gaming events. These events each lead to activating a haptic event at block 615, which may occur simultaneously to the gaming routines in the various states in which the gaming machine operates with background music.

The implementation of block 615 may be done by a haptics controller 219 running on the gaming machine 100. In other versions, haptics controller 219 may run on a central multimedia server, which may process music files or streams in advance and provide instructions to the individual gaming machines on a gaming network. Such a system may also be modified to generate haptic events to correspond to designated beat events and other audio events. Other haptic events may be generated by game software independent of audio events. The haptic events may be sent as an inter-process message through a virtual message bus such as a Spread Unified Messaging Bus, or may be another suitable type of software message or interrupt event. Generally, the different processes at blocks 616, 618, 620, 622, and 624 may not always be running as process threads or related groups of process threads, or may be placed in a state in which they do not respond to haptic events. The block diagrams herein show behavior in which such processes are, according to their programming, in a state to respond to the haptic events as depicted. The game display process, as shown at block 616, may activate any number of graphic elements on a beat, such as animating a flash or pulse of light for a reel symbol 58, or animating a change in reel symbols with the beat. An associated haptic event at block 615 typically occurs simultaneously to game and audio events. In some versions, haptic events are sent as an inter-process message on a virtual unified message bus. Such messages may be sent between networked devices, over a local bus, or to different processes in the same processor, which may be running on different processor cores or the same processor core.

It is noted the ellipsis between blocks 618 and 620 indicate that more gaming processes may be present which respond in different ways to haptic events or to beat events in the game soundtrack or background music. The depicted order of events is not limiting as the processes are typically event driven and run in parallel.

Next at block 2024, a payline cycling process is shown to receive the beat event. This process runs during the award phase of a winning game in which the wagering game includes multiple paylines which are evaluated for game results in a payline evaluation phase of the game play session. The response software code typically includes instructions for providing a graphical display of cycling through the payline evaluation synchronized with the beats in the played audio, as seen at block 2026. The beats can be main beats of a measure, with no response on off beats, mimicking an arrangement in which the display has a custom animation sequence for each song. The game event audio process may also have an associated haptic event as shown at block 618. Other gaming processes such as the lighting display process (block 620), the payline cycling process (block 622), and the award bangup process (block 624) may also include have an associated haptic event at block 615.

While the system computer executable instructions described above are preferably executed by a Class III gaming machine as further discussed below, it should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted method, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting. The division of game logic steps between gaming machines and servers is known in the art and may be accomplished according to suitable methods allowed for the relevant gaming jurisdictions.

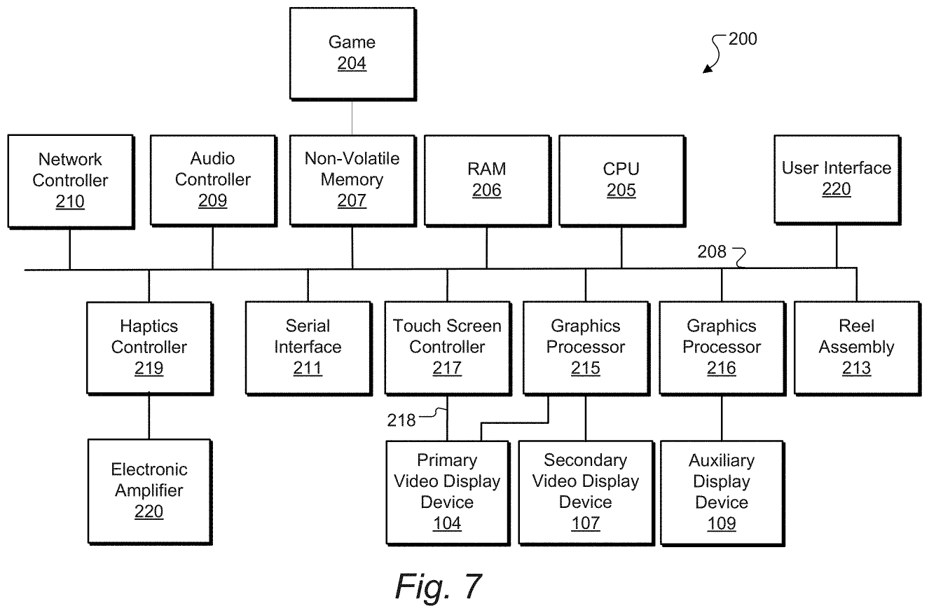

FIG. 7 shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and may also include a secondary video display device 107 (both mounted on cabinet 101). A second graphics processor 216 may also connected on bus 208 in this example to drive the auxiliary display device 109. Haptics controller 219 is connected to system bus 208 and provides control signaling to electronic amplifier 220, which is coupled to drive vibrating device 128. Gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 7 may be implemented with known electronic components and motherboards used in the gaming industry. The various electronic components may be mounted in a common housing in gaming machine 100 or on one or more circuit boards housed within cabinet 101 without a separate enclosure. Those familiar with data processing systems and the various data processing elements shown in FIG. 7 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 7 as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern gaming systems. Although separate graphics processor 215 is shown for controlling primary video display device 104, secondary video display device 107, and graphics processor 216 is shown for controlling auxiliary display device 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display and perform the haptic feedback techniques of the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the player selection round as will be discussed below in connection with FIGS. 3A-B.

FIG. 3C shows a software module block diagram according to one example version of the invention. The software modules depicted may be instantiated as processes communicating with inter-thread messaging according to suitable techniques known in the art. Generally, the modules employed for synchronizing the multimedia presentation with the musical soundtrack are highlighted with dotted blocks. The Spread unified messaging bus, a virtual messaging bus, may be employed as shown to implement the beat messages passed to the UI and Script Engine modules, which generally contain the gaming presentation software program code. While this architecture is shown, many other software designs are possible within the scope of the invention to achieve the same result.

It should be noted that the invention is not limited to gaming machines employing the personal computer-type arrangement of processing devices and interfaces shown in example gaming machine 100. Other gaming machines through which the automated multimedia presentation techniques herein are implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement the base game within the scope of the present invention using an electro mechanical arrangement or even a purely mechanical arrangement for displaying the symbols needed to complete the game as described herein. However, the most preferred forms of the invention utilize one or more video display devices for displaying the spinning reels, the animated symbols, and the other synchronized multimedia animations.

Still referring to the hardware and logical block diagram 200 showing an example design for a gaming machine 100, the depicted machine in operation is controlled generally by CPU 205 which stores operating programs and data in memory 207 with wagering game software code 204, user interface 220, network controller 210, audio/visual controllers, and reel assembly 213 (if a mechanical reel configuration). CPU or game processor 205 may comprise a conventional microprocessor, such as an Intel® Pentium® microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information and game processor 205 may respond according to its programming, such as to apply a wager and initiate execution of a game. Game processor 205 also may connect through network controller 210 to a gaming network (not separately shown).

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A gaming machine for providing a wagering game, the gaming machine comprising:
a cabinet,
a display mounted in the cabinet,
an audio device mounted in the cabinet,
a wager input device mounted in the cabinet,
a haptic device mounted along a lower front face of the cabinet and extending toward a player area in front of the cabinet, the haptic device comprising:
a vibration plate positioned to tilt facing upward and toward the player area as a footrest;
a base and a suspension mounted on the base carrying the vibrational plate and allowing vibrational movement of the vibrational plate;
one or more voice coil vibrating devices mechanically coupled to the vibrational plate along its lower side; and
an electronic amplifier electrically connected to the voice coil vibrating devices;
at least one electronic controller operatively coupled to the wager input device, the audio device, the display, and the electronic amplifier and configured to execute instructions related to the wagering game and to cause cash value credits to be awarded to a player in response to wagering wins;
tangible, non-transitory electronically accessible memory coupled to the at least one electronic controller and containing program code executable by the at least one electronic controller to:
receive a notification of a gaming event requiring an associated haptic;
obtain haptic parameters for the gaming event; and
cause the electronic amplifier to drive the voice coil vibrating devices to vibrate according to the haptic parameters.

2. The gaming machine of claim 1, in which the haptic device is also operable as a bass audio transducer.

3. The gaming machine of claim 1, in which the haptic device is provided as a detachable device that can be used to upgrade a gaming machine.

4. The gaming cabinet of claim 1, in which the one or more voice coil vibrating devices are mechanically coupled to the vibrational plate along its lower side with a closed tube.

5. The gaming machine of claim 1, in which tube is attached to the voice coil through conical element.

6. The gaming machine of claim 1, further comprising a lighting display including one or more lights having control electronics operatively coupled to the at least one electronic controller; and in which the program code is further operable to respond to designated vibrational events by causing the lighting display to change its state synchronous to the vibrational events.

7. The gaming machine of claim 1, in which the program code further comprises instructions for synchronizing animations of gaming symbols on an array of symbols to vibrations of the haptic device.

8. The gaming machine of claim 1, in which the suspension comprises a foam layer.

9. The gaming cabinet of claim 1, in which the haptic device is operable to vibrate at sub-sonic frequencies and sonic frequencies.

10. The gaming cabinet of claim 1, in which the haptic device further comprises a pressure sensor operable to detect when a player is in contact with the haptic device, and the program code further comprises instructions to disable the haptic device in the absence of the contact, and enable it in the presence of the contact.

11. A method of providing haptic for a wagering game cabinet having a display, a wager input device, an audio device, a display, a haptic device, and at least one electronic controller operatively coupled to the wager input device, the audio device, and the display and configured to execute instructions related to the wagering game, the method comprising:
(a) receiving an instruction that a haptic event is to occur during a game play session;
(b) in response, processing haptic parameters to determine one or more frequencies and durations for the haptic event;
(c) activating an electronic amplifier to feed current to one or more voice coil vibrating devices in the haptic device according to the frequencies and durations, thereby vibrating a plate positioned as a footrest associated with the gaming machine.

12. The method of claim 11, in which the frequencies for the haptic event include audio frequencies.

13. The method of claim 11, in which the frequencies for the haptic event include subsonic frequencies.

14. The method of claim 13, further comprising synchronizing animations of gaming symbols on an array of symbols presented on the display to subsonic vibrations of the haptic device.

15. The method of claim 13, further comprising synchronizing lighting events on a lighting display associated with the gaming machine to subsonic vibrations of the haptic device.
